(19) United States
(12) Patent Application Publication
(10) Pub. No.: US 2009/0020026 A1
(43) Pub. Date: Jan. 22, 2009

(54) PRINTING PRESS

(75) Inventors: Kazunori Seto, Hiroshima (JP); Yasuhiro Mochizuki, Hiroshima (JP); Yasuhiko Hirata, Hiroshima (JP); Hajime Yagi, Hiroshima (JP); Satoshi Morimoto, Hiroshima (JP); Takeshi Satoh, Hiroshima (JP); Yoshiro Matsuura, Hiroshima (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., TOKYO (JP)

(21) Appl. No.: 12/162,765

(22) PCT Filed: Jan. 29, 2007
(86) PCT No.: PCT/JP2007/051397

§ 371 Date: Jul. 30, 2008

(30) Foreign Application Priority Data
Jan. 31, 2006 (JP) 2006-023717

(51) Int. Cl. B41F 7/02

(52) U.S. Cl. 101/217

(57) ABSTRACT

A printing press is configured such that the printing sheet is supplied from the paper feeding unit through the intermediate cylinder 14 while the ink is supplied from the ink apparatus to the blanket cylinder 11 through the printing cylinder 12 and, when the printing sheet passes between the blanket cylinder 11 and the impression cylinder 13, the ink is transferred from the blanket cylinder 11 and, thereby, printing is executed. In the printing press, the rotary encoder 31 detects the rotation angle of the blanket cylinder 11 and the control unit 32 receives the instructions of the head portion finding switches 33b, 33c and drives and controls the driving unit 16 and, thereby, the blanket cylinder 11 can be rotated and stopped to/at the blanket replacement angle for replacing the blanket 28 wound around the blanket cylinder 11.

### RELATED APPLICATIONS

The present application is based on International Application PCT/JP2007/051397, filed Jan. 29, 2007 which claims priority from, Japan Application Number 2006-023717, filed Jan. 31, 2006, the disclosures of which are hereby incorporated by reference herein in their entirety.

### TECHNICAL FIELD

The present invention relates to a printing press that executes printing therein by supplying a printing sheet from a paper feeding unit through an intermediate cylinder while by supplying ink from an ink apparatus to a blanket cylinder through a printing cylinder, and by transferring the ink from the blanket cylinder to the printing sheet when the printing sheet passes between the blanket cylinder and an impression cylinder.

### BACKGROUND ART

In an ordinary off-set printing press, printing units respectively for a plurality of ink colors (such as, for example, cyan, magenta, yellow, black, and other colors including special colors as necessary) are disposed along a transporting path for printing sheets, and each of the printing units has an ink supplying apparatus. Therefore, ink for which the amount thereof to be supplied is adjusted by the ink apparatus is supplied to the cylinder face of a printing cylinder through a group of ink rollers, and ink adhering to the cylinder face is supplied to a blanket cylinder. When a printing sheet passes between the blanket cylinder and an impression cylinder, the ink is transferred from the blanket cylinder to the printing sheet as a picture pattern and, thereby, printing is executed.

The components configuring one printing unit such as an intermediate cylinder, a printing cylinder, a blanket cylinder, and an impression cylinder need maintenance to be executed between printing sessions. For example, for the printing cylinder, a lithographic plate thereof needs to be replaced every time the item to be printed is changed and, for the blanket cylinder, the blanket thereof needs to be replaced when the blanket is degraded by using for a long time. For the intermediate cylinder and the impression cylinder, a pawl is provided on each of the cylinders to grip a printing sheet to be transported and oiling is needed to a cam mechanism that actuates the pawl.

When maintenance is executed to the above cylinders, each cylinder needs to be stopped at a predetermined rotation angle. In general, a cylinder jog button is provided on an operation panel to rotate each cylinder by a fine angle at one time. Various types of maintenance is executed to each cylinder by rotating the cylinder gradually by a fine angle at one time and stopping the cylinder at a predetermined rotation angle, utilizing the cylinder jog button.

A printing press for which replacement of a lithographic plate is executed for a printing cylinder thereof can be, for example, a printing press described in the following Patent Document 1.

Patent Document 1: Japanese Patent Application Laid-Open No. H06-226956

### DISCLOSURE OF INVENTION

### Problem to be Solved by the Invention

However, for example, when a blanket cylinder is stopped at a predetermined rotation angle by using a cylinder jog button provided on an operation panel during blanket replacing work, a worker needs to rotate the blanket cylinder gradually by a fine angle at one time by operating the cylinder jog button visually observing the rotation position of the blanket cylinder and, thereby, not only the work becomes bothersome and takes a long time but also the load on the worker becomes significant. On the other hand, when each of an intermediate cylinder and an impression cylinder is stopped at a predetermined rotation angle during oiling work for those cylinders, the oiling position of each of the intermediate cylinder and the impression cylinder is located at a position hidden by a cover and, therefore, the worker can not rotate the cylinders by operating an operation button visually observing the rotation position of each cylinder and the worker executes the button operation estimating the stop position based on the experience of the worker and, thereby, the work becomes difficult and takes a long time.

The present invention solves the above problems and the object thereof is to provide a printing press that facilitates improvement of the workability in various types of maintenance work by stopping printing press cylinders at predetermined rotation positions with high precision.

### Means to Solve the Problems

According to an aspect of the present invention, a printing press that executes printing therein by supplying a printing sheet from a paper feeding unit through an intermediate cylinder, by supplying ink from an ink apparatus to a blanket cylinder through a printing cylinder, and by transferring the ink from the blanket cylinder to the printing sheet when the printing sheet passes between the blanket cylinder and an impression cylinder, includes a head portion finding unit that rotates and stops at least any one of the intermediate cylinder, the printing cylinder, the blanket cylinder, and the impression cylinder to/at a predetermined working position.

In the printing press, the head portion finding unit may stop the blanket cylinder at an angle for replacing a blanket wound around the blanket cylinder.

In the printing press, an end of the blanket in the winding direction thereof may be fixed on a gripping side winding shaft of the blanket cylinder while the other end of the blanket in the winding direction thereof is fixed on the gripping tail side winding shaft of the blanket cylinder, and the head portion finding unit may stop the blanket cylinder at a work angle to fix the end of the blanket on the gripping side winding shaft and a work angle to fix the other end of the blanket on the gripping tail side winding shaft.

In the printing press, a supporting bar to apply predetermined tension to the blanket to be wound around the blanket cylinder may be provided in the vicinity of a position for replacing work of the blanket of the blanket cylinder.

In the printing press, the head portion finding unit may stop the intermediate cylinder or the blanket cylinder or the impression cylinder at an oiling angle.

In the printing press, the head portion finding unit may stop the intermediate cylinder or the blanket cylinder or the impression cylinder sequentially at a plurality of oiling angles.

In the printing press, the head portion finding unit may have a storing unit that has sequentially stored therein a plurality of oiling angles for the intermediate cylinder or the blanket cylinder or the impression cylinder.

In the printing press, the storing unit may have stored therein a plurality of stopping-for-oiling patterns, and the head portion finding unit may select and execute a predetermined stopping-for-oiling pattern from the plurality of stopping-for-oiling patterns in response to a head portion finding instruction.

### EFFECT OF THE INVENTION

According to the printing press of the present invention, the printing press is configured to execute printing therein by supplying the printing sheet from the paper feeding unit through the intermediate cylinder while by supplying ink from the ink apparatus to the blanket cylinder through the printing cylinder, and by transferring the ink from the blanket cylinder to the printing sheet when the printing sheet passes between the blanket cylinder and the impression cylinder, and the head portion finding unit is provided that can rotate and stop at least any one of the intermediate cylinder, the printing cylinder, the blanket cylinder, and the impression cylinder to/at the predetermined work angle. Therefore, the intermediate cylinder, the printing cylinder, the blanket cylinder, and the impression cylinder can be stopped easily and with high precision at the predetermined rotation angle and, thereby, various types of maintenance work such as replacing parts and oiling can be easily executed. Therefore, the workability can be improved by alleviating the load on the worker.

Further, according to the present invention, the blanket cylinder can be stopped at the angle for replacing the blanket wound around the blanket cylinder by the head portion finding unit and, thereby, the blanket cylinder can be stopped at the angle for replacing the blanket easily and with high precision by the head portion finding unit. Therefore, the blanket replacing work can be easily executed.

Further, according to the present invention, the end of the blanket in the winding direction thereof is fixed on the gripping side winding shaft of the blanket cylinder while the other end of the blanket in the winding direction thereof is fixed on the gripping tail side winding shaft of the blanket cylinder and the blanket cylinder can be stopped by the head portion finding unit at the work angle to fix the end of the blanket on the gripping side winding shaft and at the work angle to fix the other end of the blanket on the gripping tail side winding shaft. Thereby, the blanket cylinder can be stopped easily and with high precision by the head portion finding unit at the work angle to fix the end of the blanket on the gripping side winding shaft and at the work angle to fix the other end of the blanket on the gripping tail side winding shaft. Therefore, the blanket replacing work can be easily executed.

Further, according to the present invention, the supporting bar to apply predetermined tension to the blanket to be wound around the blanket cylinder is provided in the vicinity of the position for the replacing work of the blanket of the blanket cylinder. Thereby, the worker can wind the blanket around the blanket cylinder and can apply predetermined tension to the blanket using the supporting bar when the blanket cylinder is stopped by the head portion finding unit at the position for the blanket replacing work. Therefore, the blanket replacing work can be securely executed.

Further, according to the present invention, the intermediate cylinder, the blanket cylinder, or the impression cylinder can be stopped by the head portion finding unit at the oiling angle. Thereby, the intermediate cylinder, the blanket cylinder, or the impression cylinder can be stopped easily and with high precision by the head portion finding unit at the oiling angle. Therefore, the oiling work can easily be executed.

Further, according to the present invention, the intermediate cylinder, the blanket cylinder, or the impression cylinder can be stopped by the head portion finding unit consecutively at the plurality of oiling angles. Thereby, even when the plurality of oiling positions are present for each of the cylinders, the cylinder can be stopped by the head portion finding unit consecutively at the plurality of oiling angles. Therefore, the oiling work can easily be executed.

Further, according to the present invention, the storing unit having sequentially stored therein the plurality of oiling angles for the intermediate cylinder, the blanket cylinder, or the impression cylinder is provided by the head portion finding unit. Thereby, the storing unit has sequentially stored therein the plurality of oiling angles for each of the cylinders and each of the cylinders can automatically be stopped by the head portion finding unit at the plurality of oiling positions. Therefore, the oiling work can easily be executed.

Further, according to the present invention, the storing unit has stored therein the plurality of stopping-for-oiling patterns and the predetermined stopping-for-oiling pattern is selected from the plurality of stopping-for-oiling patterns and is executed in response to the head portion finding instruction of the head portion finding unit. Therefore, by having stored the plurality of stopping-for-oiling patterns in the storing unit, the predetermined stopping-for-oiling pattern is selected from the plurality of stopping-for-oiling patterns by the worker during the work and, thereby, the head portion finding unit can execute the predetermined stopping-for-oiling pattern and can cause each cylinder to automatically stop at the plurality of oiling positions. Therefore, the oiling work can easily be executed.

### BRIEF DESCRIPTION OF DRAWINGS

FIG. 1 is a schematic view of the purview of a printing press according to a first embodiment of the present invention.

FIG. 2 is a schematic view of blanket replacing work of a blanket cylinder in the printing press of the first embodiment.

FIG. 3 is a cross-sectional view of a blanket fitting unit of the blanket cylinder in the printing press of the first embodiment.

FIG. 4 is an explanatory view of the blanket replacing work of the blanket cylinder in the printing press of the first embodiment.

FIG. 5 is an explanatory view of the blanket replacing work of the blanket cylinder in the printing press of the first embodiment.

FIG. 6 is an explanatory view of the blanket replacing work of the blanket cylinder in the printing press of the first embodiment.

FIG. 7 is a schematic view of the purview of a printing press according to a second embodiment of the present invention.

FIG. 8 is a schematic view of oiling work for an impression cylinder and an intermediate cylinder in the printing press of the second embodiment.

FIG. 9 is a time chart of the oiling work for the impression cylinder and the intermediate cylinder in the printing press of the second embodiment.

FIG. 10 is a schematic view of the oiling work for the blanket cylinder in the printing press of the second embodiment.

FIG. 11 is a time chart of the oiling work for the blanket cylinder in the printing press of the second embodiment.

### EXPLANATIONS OF LETTERS OR NUMERALS

11, 63, 73 blanket cylinder
12, 62, 72 printing cylinder
13, 64, 74 impression cylinder
14, 15, 65, 75 intermediate cylinder
16, 81 driving unit
21 recessed portion
22 gripping side winding shaft
23 gripping tail side winding shaft
26, 27 press bar
28 blanket
31, 82 rotary encoder
32, 83 control unit (head portion finding unit)
33, 84 operating unit
33b first head portion finding switch
33c second head portion finding switch
41 supporting bar
52 safety switch
63a, 63b, 64a, 64b, 65a, 74a, 74b, 75a, 75b oiling position
84b mode switching switch
84c head portion finding switch
85 storing unit

### BEST MODE(S) FOR CARRYING OUT THE INVENTION

Referring to the accompanying drawings, description will be given below in detail for preferred embodiments of a printing press according to the present invention. The present invention is not limited by the embodiments.

### FIRST EMBODIMENT

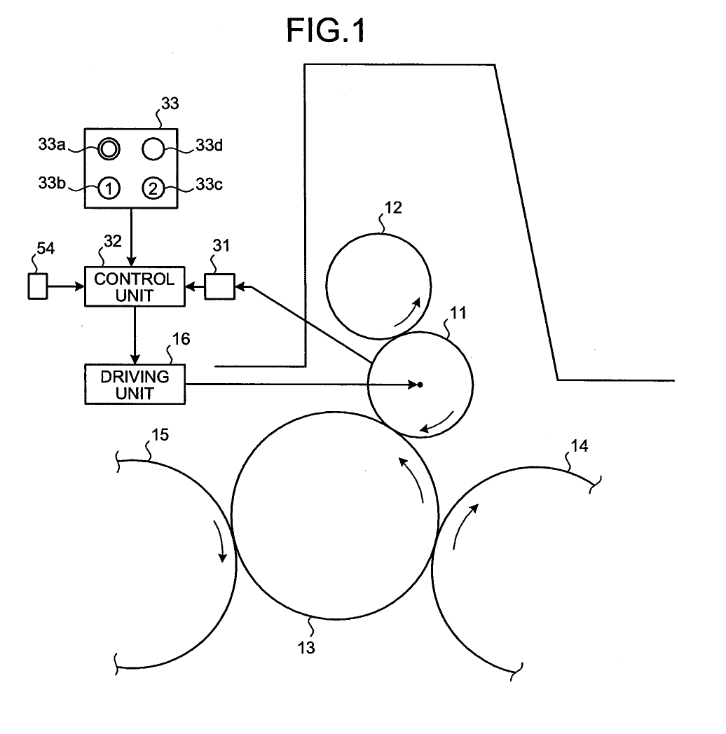

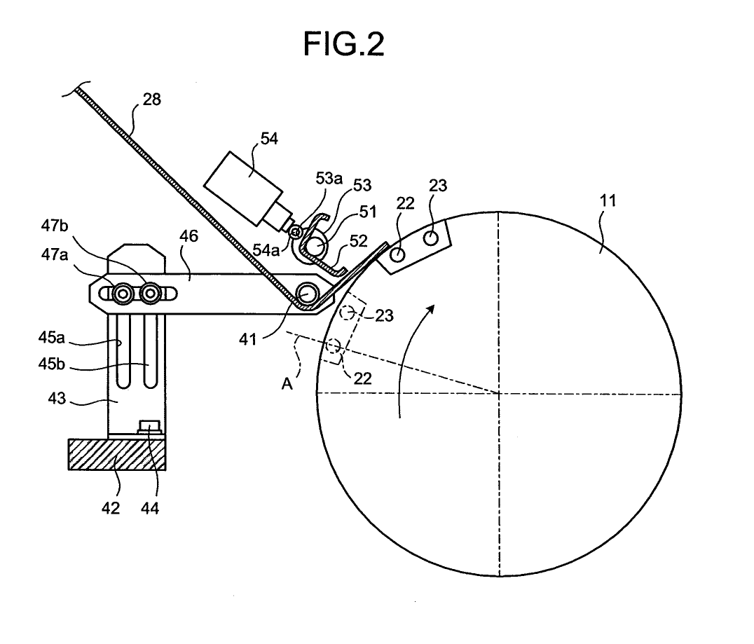

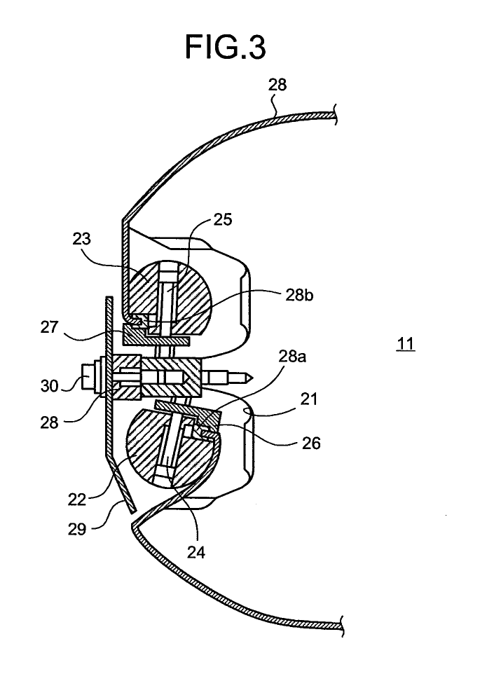

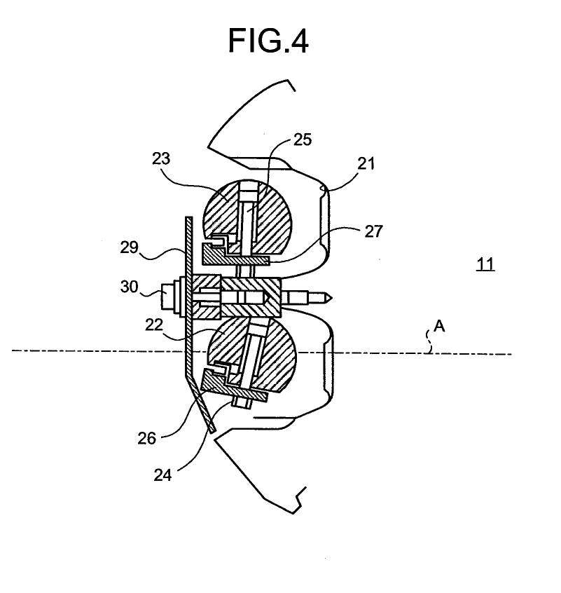

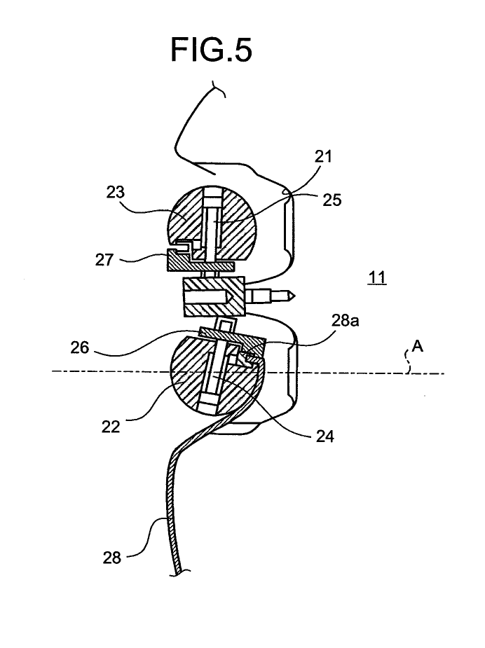

FIG. 1 is a schematic view of the purview of a printing press according to a first embodiment of the present invention. FIG. 2 is a schematic view of blanket replacing work of a blanket cylinder in the printing press of the first embodiment. FIG. 3 is a cross-sectional view of a blanket fitting unit of the blanket cylinder in the printing press of the first embodiment. FIGS. 4 and 5 are explanatory views of the blanket replacing work of the blanket cylinder in the printing press of the first embodiment.

An off-set sheet-fed printing press applied with a printing press of a first embodiment is configured by a paper feeding apparatus, a plurality of printing units respectively for ink colors arranged along a transporting path for printing sheets, and a paper ejecting apparatus. In one of the printing units, as shown in FIG. 1, a blanket cylinder 11 and a printing cylinder 12 are disposed in the upper portion sandwiching the transporting path for the printing sheets while an impression cylinder 13 is disposed in the lower portion. Intermediate cylinders 14, 15 are disposed before and after the impression cylinder 13. An ink supplying apparatus (not shown) that supplies ink around the printing cylinder 12 is provided above the printing cylinder 12.

Therefore, ink is supplied from the ink supplying apparatus to the cylinder face of the printing cylinder 12. The ink adhering to the cylinder face is transferred to the blanket cylinder 11. When a printing sheet passes between the blanket cylinder 11 and the impression cylinder 13 from the intermediate cylinder 14, the impression cylinder 13 applies a predetermined printing pressure to the printing sheet and, thereby, the ink on the blanket cylinder 11 is transferred to the printing sheet as a picture pattern and, in this way, printing is executed.

In the above printing press, the blanket cylinder 11, the printing cylinder 12, the impression cylinder 13, and the intermediate cylinders 14, 15 are connected through gears, and the blanket cylinder 11, the printing cylinder 12, the impression cylinder 13, and the intermediate cylinders 14, 15 can be rotated by a driving unit (a driving motor) 16 being synchronized with each other along the direction indicated by an arrow as shown in FIG. 1.

In the printing press of the embodiment configured as above, a head portion finding unit is provided that rotates and stops the blanket cylinder 11 to/at a blanket replacement angle during replacement work to replace a blanket wound around the blanket cylinder 11.

That is, as shown in FIGS. 2 and 3, a recessed portion 21 is formed in the outer periphery of the blanket cylinder 11 along the direction of a shaft thereof. Inside the recessed portion 21, a gripping side winding shaft 22 and a gripping tail side winding shaft 23 are disposed in parallel to each other. Press bars 26, 27 are attached respectively to winding shafts 22, 23 respectively by fitting bolts 24, 25. Fitting bars 28a, 28b fixed respectively on the ends of a blanket 28 can be clipped respectively by these press bars 26, 27. A cover 29 is fixed on the blanket cylinder 11 by a fixing bolt 30 as the cover 29 covers over the recessed portion 21.

When a worker attaches the blanket 28 to the blanket cylinder 11, the worker rotates and stops the blanket cylinder 11 such that the gripping side winding shaft 22 is positioned at a predetermined working position A; fixes the fitting bar 28a of the blanket 28 at this position; rotates and stops the blanket cylinder 11 such that the gripping tail side winding shaft 23 is positioned at the predetermined working position A; and fixes the fitting bar 28b of the blanket 28 at this point. Therefore, in the embodiment, during the attaching work of the blanket 28 to the blanket cylinder 11, the head portion finding is executed such that the gripping tail side winding shaft 23 is stopped at the working position A and the gripping tail side winding shaft 23 is stopped at the working position A.

More specifically, as shown in FIG. 1, a rotary encoder 31 is provided that detects the rotation angle (phase) of the blanket cylinder 11, and the rotation position of the blanket cylinder 11 that the rotary encoder 31 has detected is output to a control unit 32. An operating unit 33 includes a power source switch 33a, a first head portion finding switch 33b, a second head portion finding switch 33c, and a cylinder jog switch 33d; and outputs instructions by switch operation to the control unit 32. Therefore, the rotary encoder 31 outputs the rotation angle of the blanket cylinder 11 to the control unit 32 and, when the worker presses the first head portion finding switch 33b, the control unit 32 controls the driving unit 16 such that the gripping side winding shaft 22 of the blanket cylinder 11 stops at the predetermined working position A. When the worker presses the second head portion finding switch 33c, the control unit 32 controls the driving unit 16 such that the gripping tail side winding shaft 23 of the blanket cylinder 11 stops at the predetermined working position A.

In the printing press of the embodiment, as shown in FIG. 2, a supporting bar 41 to apply predetermined tension to the blanket 28 is provided in the vicinity of the working position A at which the blanket cylinder 11 stops when a worker attaches the blanket 28 to the blanket cylinder 11. That is, the working position (angle) A for the replacement work of the blanket 28 is provided on the blanket cylinder 11 and the control unit 32 controls the driving unit 16 such that the gripping side winding shaft 22 and the gripping tail side winding shaft 23 of the blanket cylinder 11 are stopped at the working position A.

A pair of fitting brackets 43 on the right and the left is fixed to a frame 42 with bolts 44. A pair of base end portions of a supporting arm 46 is coupled to slots 45a, 45b respectively of fitting brackets 43 respectively with bolts 47a, 47b. Each end of the supporting bar 41 is fixed by the tip portion of the supporting arm 46. In this case, the position and the angle of the supporting arm 46 are changed by moving the base end portions of the supporting arm 46 along the slots 45a, 45b and, thereby, the position of the supporting bar 41 can be adjusted.

A supporting shaft 51 is provided parallel to the supporting bar 41 above the supporting bar 41. On the outer periphery of the supporting shaft 51, a safety switch 52 is fixed and a cam roller 53 is fixed. A detecting portion 54a of a detecting switch 54 presses a recessed portion 53a of the cam roller 53.

Therefore, the worker fixes the fitting bar 28a of the blanket 28 to the gripping side winding shaft 22 of the blanket cylinder 11 and, thereafter, when the blanket cylinder 11 is rotated by the driving unit 16 in the direction of the arrow in FIG. 2, the blanket 28 is wound on the outer periphery face of the blanket cylinder 11. At this time, when the worker grabs the other end of the blanket 28, the blanket 28 contacts the supporting bar 41 and is wound on the outer periphery face of the blanket cylinder 11 being counter-rotated. Therefore, the predetermined tension is applied by the supporting bar 41 to the blanket 28. At this time, when the worker touches the safety switch 52, the safety switch 52 moves and, thereby, the supporting shaft 51 rotates. Thereby, the detecting portion 54a of the detecting switch 54 is removed from the recessed portion 53a of the cam roller 53 and, thereby, the detecting switch 54 is turned on and the control unit 32 controls the driving unit 16 to stop the rotation of the blanket cylinder 11. Therefore, the safety of the worker can be secured.

Description will be given in detail for the above attaching work of the blanket 28 for the printing press of the embodiment.

As shown in FIG. 1, the worker first presses the first head portion finding switch 33b of the operating unit 33 to fix an end of the blanket 28 to the blanket cylinder 11. The control unit 32 receives an instruction from the operating unit 33 and controls the driving unit 16 to rotate the blanket cylinder 11 in the direction of the arrow and, as shown in FIG. 2, stop the blanket cylinder 11 such that the gripping side winding shaft 22 is positioned at the predetermined working position A. As shown in FIG. 4, the worker then loosens the fixing bolt 30 and removes the cover 29. The worker then opens a press bar 26 of the gripping side winding shaft 22 with the worker's fingers, inserts the fitting bar 28a of the blanket 28 into a groove between the gripping side winding shaft 22 and the press bar 26, and fixes the fitting bar 28a by closing the press bar 26. As shown in FIG. 5, the worker winds the end of the blanket 28 into the inside of the recessed portion 21 by rotating the gripping side winding shaft 22 in the direction of the arrow by a predetermined angle using a tool now shown.

As above, when the fitting bar 28a of the blanket 28 has been fixed to the gripping side winding shaft and has been wound into the inside of the recessed portion 21, the worker, as shown in FIG. 1, presses the second head portion finding switch 33c of the operating unit 33 to fix the other end of the blanket 28 to the blanket cylinder 11. The control unit 32 receives an instruction from the operating unit 33 and controls the driving unit 16 to rotate the blanket cylinder 11 in the direction of the arrow. At this time, the worker grabs the other end of the blanket 28 and winds the blanket 28 on the outer periphery face of the blanket cylinder 11 causing the blanket 28 to contact the supporting bar 41 and, thereby, causes the supporting bar 41 to apply the predetermined tension to the blanket 28. At this time, when the worker touches the safety switch 52, the safety switch 52 moves and, thereby, the detecting switch 54 is turned on and the control unit 32 controls the driving unit 16 to stop the rotation of the blanket cylinder 11. Therefore, accidents such as being caught of a hand by the cylinder can be prevented.

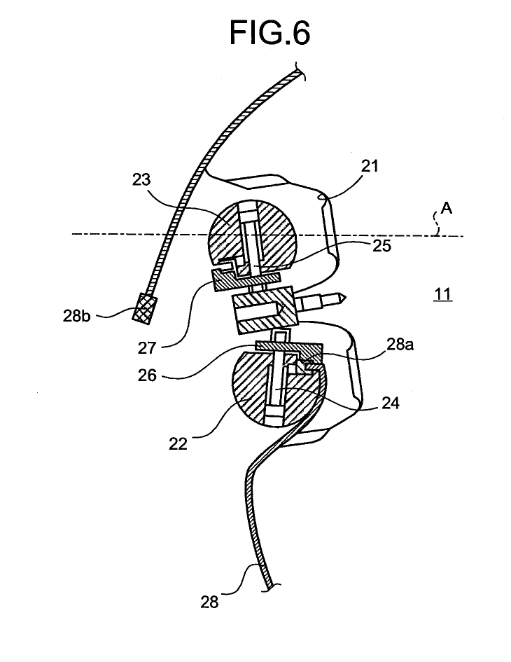

The driving unit 16 rotates the blanket cylinder 11 and, as shown in FIG. 6, when the gripping tail side winding shaft 23 arrives at the predetermined working position A, the control unit 32 causes the driving unit 16 to stop the rotation of the blanket cylinder 11. The worker then opens a press bar 27 of the gripping tail side winding shaft 23 with the worker's fingers, inserts the fitting bar 28b of the blanket 28 into a groove between the gripping tail side winding shaft 23 and the press bar 27, and fixes the fitting bar 28b by closing the press bar 27. The worker rotates the gripping tail side winding shaft 23 in the direction of the arrow using a tool and, thereby, stretches the blanket 28 and causes the predetermined tension to be maintained. Thereafter, the worker fixes the cover 29 by tightening the fixing bolt 30.

As above, the printing press of the first embodiment is configured such that the printing sheet is supplied from the paper feeding unit through the intermediate cylinder 14 while the ink is supplied from the ink apparatus to the blanket cylinder 11 through the printing cylinder 12 and, when the printing sheet passes between the blanket cylinder 11 and the impression cylinder 13, the ink is transferred from the blanket cylinder 11 and, thereby, printing is executed. In the printing press, the rotary encoder 31 detects the rotation angle of the blanket cylinder 11 and the control unit 32 receives the instructions of the head portion finding switches 33b, 33c and drives and controls the driving unit 16 and, thereby, the blanket cylinder 11 can be rotated and stopped to/at the blanket replacement angle for replacing the blanket 28 wound around the blanket cylinder 11.

Therefore, by only pressing the head portion finding switches 33b, 33c, the control unit 32 is caused to drive and control the driving unit 16 and, thereby, the blanket cylinder 11 is securely rotated to the blanket replacement angle. Therefore, the blanket cylinder 11 can be stopped at the predetermined working position A easily and with high precision and the maintenance work can easily be executed. Therefore, the load on the worker can be alleviated and the workability can be improved.

The printing press is also configured such that, when the first head portion finding switch 33b is pressed, the control unit 32 controls the driving unit 16 to cause the gripping side winding shaft 22 of the blanket cylinder 11 to stop at the predetermined working position A while, when the second head portion finding switch 33c is pressed, the control unit 32 controls the driving unit 16 to cause the gripping tail side winding shaft 23 of the blanket cylinder 11 to stop at the predetermined working position A. Therefore, the blanket cylinder 11 can be stopped easily and with high precision at the rotation angle with which the gripping side winding shaft 22 that fixes the end of the blanket 28 stops at the working position A and at the rotation angle with which the gripping tail side winding shaft 23 that fixes the other end of the blanket 28 stops at the working position A. Therefore, the blanket replacement work can easily be executed.

In addition, the supporting bar 41 to apply the predetermined tension to the blanket 28 to be wound around the blanket cylinder 11 is provided. Therefore, when the blanket cylinder 11 is stopped at the blanket replacement position, the worker can wind the blanket 28 around the blanket cylinder 11 and can apply the predetermined tension to the blanket 28 using the supporting bar 41. Therefore, the blanket replacement work can securely be executed.

### SECOND EMBODIMENT

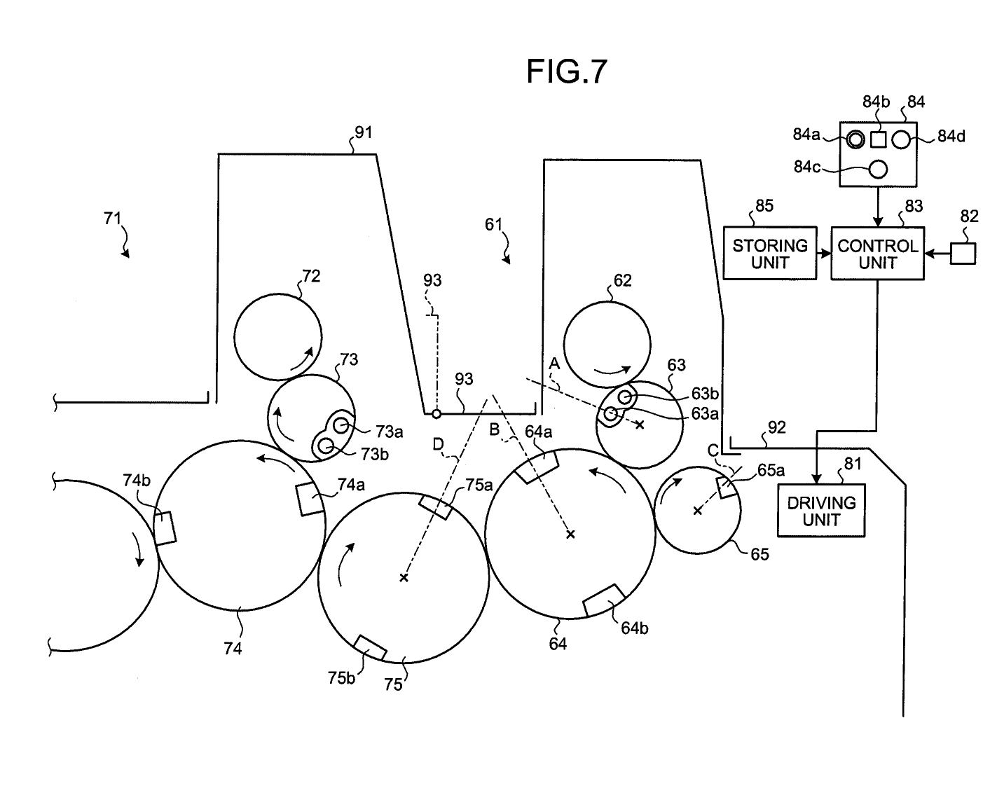

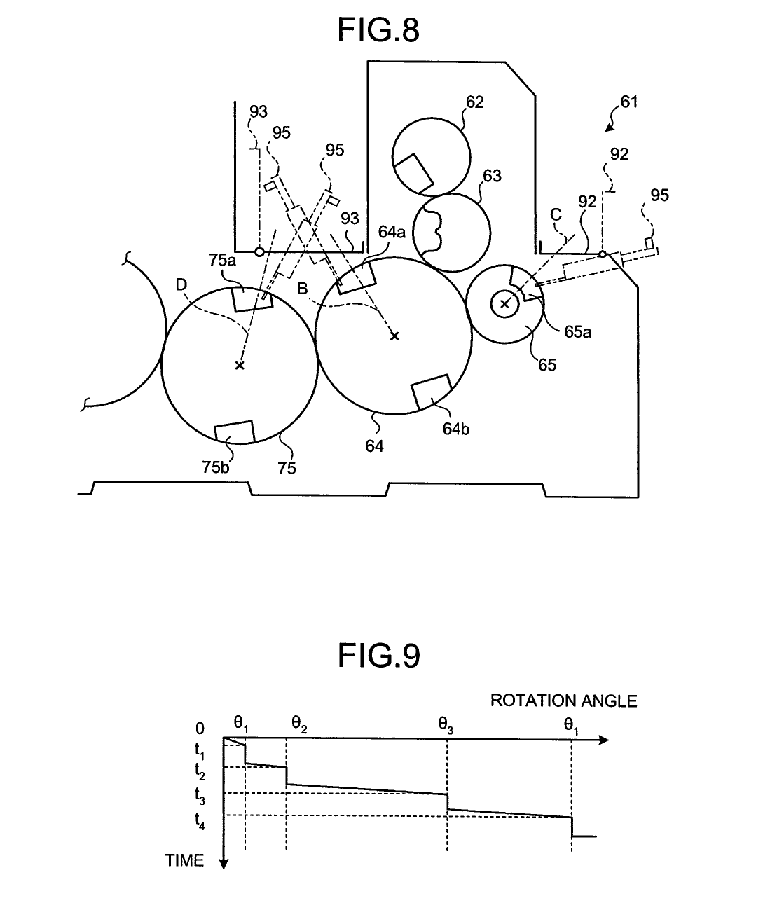

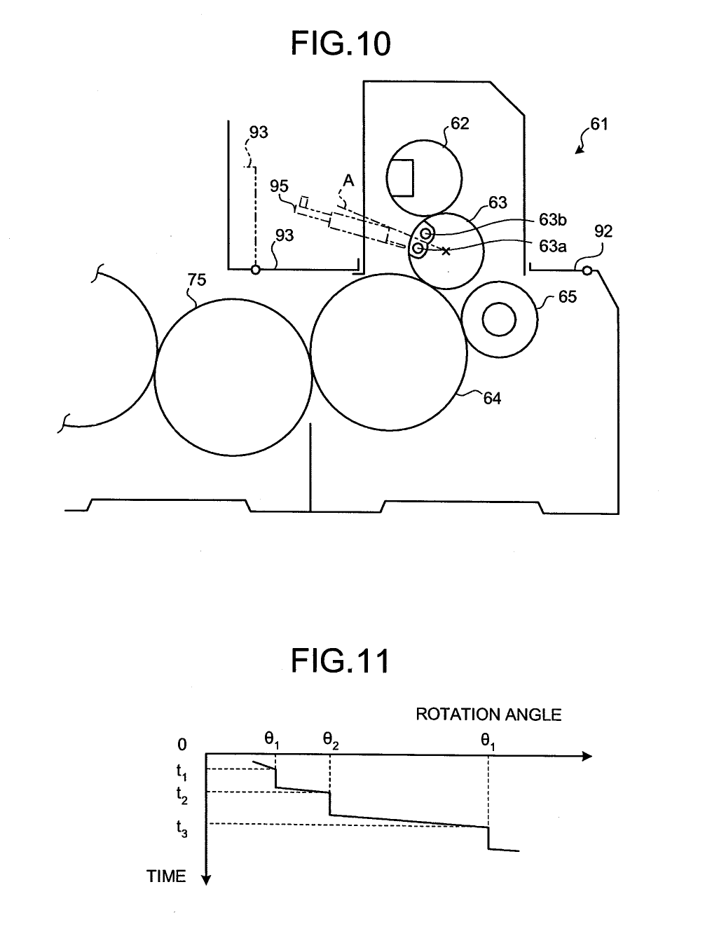

FIG. 7 is a schematic view of the purview of a printing press according to a second embodiment of the present invention. FIG. 8 is a schematic view of oiling work for an impression cylinder and an intermediate cylinder in the printing press of the second embodiment. FIG. 9 is a time chart of the oiling work for the impression cylinder and the intermediate cylinder in the printing press of the second embodiment. FIG. 10 is a schematic view of the oiling work for the blanket cylinder in the printing press of the second embodiment. FIG. 11 is a time chart of the oiling work for the blanket cylinder in the printing press of the second embodiment.

An off-set sheet-fed printing press applied with a printing press of the second embodiment is configured by a paper feeding apparatus, a plurality of printing units respectively for ink colors arranged along a transporting path of printing sheets, and a paper ejecting apparatus. In the printing units, as shown in FIG. 7, a first printing unit 61 has a printing cylinder 62, a blanket cylinder 63, and an impression cylinder 64 and a second printing unit 71 similarly has a printing cylinder 72, a blanket cylinder 73, and an impression cylinder 74. An intermediate cylinder 65 is disposed against the impression cylinder 64 of the first printing unit 61 while an intermediate cylinder 75 is disposed between the impression cylinder 64 of the first printing unit 61 and the impression cylinder 74 of the second printing unit 71 and, above each of the printing cylinders 62, 72, an ink supplying apparatus not shown is provided that supplies ink around each of the printing cylinders 62, 72.

Therefore, ink is supplied from the ink supplying apparatus to the cylinder face of each of the printing cylinders 62, 72. The ink adhered to the cylinder face is transferred to each of the blanket cylinders 63, 73. When a printing sheet passes between the blanket cylinder 63 and the impression cylinder 64 of the first printing unit 61 from the intermediate cylinder 65, the impression cylinder 64 applies a predetermined printing pressure to the printing sheet and, thereby, the ink of a first color on the blanket cylinder 63 is transferred onto the printing sheet as a picture pattern and, when the printing sheet passes between the blanket cylinder 73 and the impression cylinder 74 of the second printing unit 71 from the intermediate cylinder 75, the impression cylinder 74 applies a predetermined printing pressure to the printing sheet and, thereby, the ink of a second color on the blanket cylinder 73 is transferred onto the printing sheet as a picture pattern. Similarly, a plural colors of ink is transferred onto the printing sheet a picture patterns and, thereby, printing is executed.

In the above printing press, the printing cylinders 62, 72, the blanket cylinder 63, 73, the impression cylinders 64, 74, and the intermediate cylinders 65, 75 are connected through gears, and can be rotated by a driving unit (a driving motor) 81 being synchronized along the direction indicated by an arrow as shown in FIG. 7.

In the printing press of the embodiment configured as above, respectively for the printing units 61, 71, head portion finding units are provided that respectively cause the blanket cylinders 63, 73, the impression cylinders 64, 74, and the intermediate cylinders 65, 75 to rotate and stop to/at a plurality of oiling angles thereof during oiling work to oil to oiling portions of the blanket cylinders 63, 73, the impression cylinders 64, 74, and the intermediate cylinders 65, 75.

That is, for each of the blanket cylinders 63, 73, regular oiling is necessary to a cam unit that supports the ends of the blanket. On each of the impression cylinders 64, 74 and the intermediate cylinders 65, 75, a pawl is provided to grip a printing sheet to be transported and oiling is necessary to a cam mechanism that actuates the pawl. That is, the blanket cylinders 63, 73 each have two oiling positions 63a, 63b, 73a, 73b; the impression cylinders 64, 74 each have two oiling positions 64a, 64b, 74a, 74b; and the intermediate cylinders 65, 75 also have oiling positions 65a, 75a, 75b.

For example, when a worker oils the oiling positions 63a, 63b of the blanket cylinder 63 in the printing unit 61, the worker rotates and stops the blanket cylinders 63 such that each of the oiling positions 63a, 63b is positioned at the predetermined working position A and, at these positions, oiling to each of the oiling positions 63a, 63b is executed. When the worker oils the oiling positions 64a, 65a, 75a of the impression cylinder 64 and the intermediate cylinders 65, 75, the worker rotates and stops the impression cylinder 64 and the intermediate cylinders 65, 75 such that the oiling positions 64a, 65a, 75a are respectively positioned at predetermined working positions A, B, C, and D and, at these positions, oiling to the oiling positions 64a, 75a is executed.

More specifically, a rotary encoder 82 is provided that detects the rotation angles (phases) of the blanket cylinder 63, the impression cylinder 64, the intermediate cylinders 65, 75 and the rotation positions of the cylinders 63, 64, 75 that the rotary encoder 82 has detected are output to a control unit 83. An operating unit 84: includes a power source switch 84a, a mode switching switch 84b, a head portion finding switch 84c, and a cylinder jog switch 84d; and outputs instructions by switch operation to the control unit 83. A storing unit 85 has stored therein two stopping-for-oiling patterns that can be selected and switched by the mode switching switch 84b and the control unit 83 selects and executes a predetermined stopping-for-oiling pattern in response to an instruction by the mode switching switch 84b. In this case, a first stopping-for-oiling pattern that can be switched to by the mode switching switch 84b causes the oiling positions of the impression cylinder 64 and the intermediate cylinders 65, 75 to be sequentially stopped at each of the working positions B, C, D, and a second stopping-for-oiling pattern causes the oiling positions of the blanket cylinder 63 to be sequentially stopped at the working position A. In this case, for example, the first stopping-for-oiling pattern is implemented every two weeks and the second oiling pattern is implemented every three months.

The head portion finding switch 84c causes each of the oiling positions 63a, 64a, 75a of the blanket cylinder 63 or the impression cylinder 64 and the intermediate cylinders 65, 75 to be stopped at each of the working positions A, B, C, and D, and causes each of the oiling positions 63b, 64b, 75b of the blanket cylinder 63 or the impression cylinder 64 and the intermediate cylinders 65, 75 to be stopped at each of the working positions A, B, C, and D. In this case, covers 92, 93 for maintenance are provided on a frame 91 of the printing press. After head portion finding has been executed for each of the cylinders, these covers 92, 93 are opened and the oiling work is executed. The covers 92, 93 for maintenance are provided on frame 91 of the printing press. After head portion finding has been executed for each of the cylinders, these covers 92, 93 are opened and the oiling work is executed using an oiling gun 95.

Therefore, the rotary encoder 82 outputs to the control unit 83 the rotation angles of the blanket cylinder 63, the impression cylinder 64, the intermediate cylinders 65, 75 and, when the worker selects the first stopping-for-oiling pattern using the mode switching switch 84b and presses the head portion finding switch 84c, the control unit 83 controls the driving unit 81 such that each of the oiling positions 64a, 65a, 75a of the impression cylinder 64 and the intermediate cylinders 65, 75 is stopped at each of the working positions B, C, D. When the worker again presses the head portion finding switch 84c, the control unit 83 controls the driving unit 81 such that each of the oiling positions 64b, 75b of the impression cylinder 64 and the intermediate cylinders 65, 75 is stopped at each of the working positions A, B, C, D. When the worker selects the second stopping-for-oiling pattern using the mode switching switch 84b and presses the head portion finding switch 84c, the control unit 83 controls the driving unit 81 such that the oiling position 63a of the blanket cylinder 63 is stopped at the working position A. When the worker again presses the head portion finding switch 84c, the control unit 83 controls the driving unit 81 such that the oiling position 63b of the blanket cylinder 63 is stopped at the working position A.

Description will be given in detail for the oiling work for the above printing press of the embodiment.

As shown in FIG. 7, when the worker oils the oiling positions 64a, 64b, 65a, 75a, 75b of the impression cylinder 64 and the intermediate cylinders 65, 75, the worker selects the first stopping-for-oiling pattern using the mode switching switch 84b of the operating unit 84. In this state, when the worker presses the head portion finding switch 84c, the control unit 83 receives an instruction from the operating unit 84 and controls the driving unit 81 to cause the impression cylinder 64 and the intermediate cylinders 65, 75 in the direction of the arrow. As shown in FIGS. 8 and 9, the driving unit 81 stops the impression cylinder 64 and the intermediate cylinders 65, 75 at a predetermined angle θ1 at a time t1 such that the oiling position 65a is positioned at the working position C. In this case, the impression cylinder 64 and the intermediate cylinders 65, 75, etc., are driven being synchronized and, when the impression cylinder 64 is stopped at the predetermined angle θ1, the intermediate cylinders 65, 75 are stopped respectively at predetermined angles. At this time, the worker opens a cover 92 and oils the oiling position 65a using the oiling gun 95. When the oiling work has been finished, the worker closes the cover 92.

When the oiling to the oiling position 65a of the intermediate cylinder 65 has been finished and the worker then presses again the head portion finding switch 84c, the control unit 83 receives an instruction from the operating unit 84 and controls the driving unit 81 to cause the impression cylinder 64 and the intermediate cylinders 65, 75 in the direction of the arrow. At a time t2, the driving unit 81 stops the impression cylinder 64 and the intermediate cylinders 65, 75 at a predetermined angle θ2 such that the oiling positions 64a, 75a are respectively positioned at the working positions B, D. At this time, the worker opens a cover 93 and oils each of the oiling positions 64a, 65a, 75a using the oiling gun 95. When the oiling has been finished, the worker closes the cover 93.

When the oiling to each of the oiling positions 64a, 75a of the impression cylinder 64 and the intermediate cylinder 75 has been finished and the worker then presses the head portion finding switch 84c, the control unit 83 receives an instruction from the operating unit 84 and controls the driving unit 81 to cause the impression cylinder 64 and the intermediate cylinders 65, 75 in the direction of the arrow. At a time t3, the driving unit 81 stops the impression cylinder 64 and the intermediate cylinders 65, 75 at a predetermined angle θ3 such that the oiling positions 64b, 65b, 75b are respectively positioned at the working positions B, C, D. At this time, the worker opens the covers 92, 93 and oils each of the oiling positions 64b, 75b using the oiling gun 95. When the oiling has been finished, the worker closes the cover 93.

Thereafter, when the worker presses the head portion finding switch 84c, the control unit 83 controls the driving unit 81 to cause the impression cylinder 64 and the intermediate cylinders 65, 75. At a time t3, the driving unit 81 again stops the impression cylinder 64 and the intermediate cylinders 65, 75 at the predetermined angle θ1 such that the oiling position 65a is positioned at the working position C and the worker can oil the oiling position 65a again.

On the other hand, as shown in FIG. 7, when the worker oils each of the oiling positions 63a, 63b of the blanket cylinder 63, the worker selects the second stopping-for-oiling pattern using the mode switching switch 84b of the operating unit 84. In this state, when the worker presses the head portion finding switch 84c, the control unit 83 receives an instruction from the operating unit 84 and controls the driving unit 81 to cause the blanket cylinder 63 in the direction of the arrow. As shown in FIGS. 10 and 11, the driving unit 81 stops the blanket cylinder 63 at the predetermined angle θ1 at the time t1 such that the oiling position 65a is positioned at the working position A. At this time, the worker opens the cover 93 and oils the oiling position 65a using the oiling gun 95. When the oiling work has been finished, the worker closes the cover 93.

When the oiling to the oiling position 63a of the blanket cylinder 63 has been finished and the worker then presses again the head portion finding switch 84c, the control unit 83 receives an instruction from the operating unit 84 and controls the driving unit 81 to cause the blanket cylinder 63 in the direction of the arrow. At the time t2, the driving unit 81 stops the blanket cylinder at the predetermined angle θ2 such that the oiling position 63b is positioned at the working positions A. At this time, the worker opens the cover 93 and oils the oiling position 63b using the oiling gun 95. When the oiling has been finished, the worker closes the cover 93.

Thereafter, when the worker presses the head portion finding switch 84c, the control unit 83 controls the driving unit 81 to cause the blanket cylinder 63. At the time t3, the driving unit 81 again stops the blanket cylinder 63 at the predetermined angle θ1 such that the oiling position 63b is positioned at the working position A, and oiling to the oiling position 63a can be again executed.

Though the case where the oiling work is executed to each cylinder of the first printing unit 61 has been described in the above embodiment, the same is true in the case where oiling work is executed to each cylinder of the second printing unit 71 and a third and a fourth printing units not shown. In this case, the worker selects a printing unit for which the oiling work is executed using a control unit for the entire printing press and executes various types of operation using the operating unit 84.

As above, in the printing press of the second embodiment: the rotary encoder 82 detects the rotation angles of the blanket cylinders 63, 73, the impression cylinders 64, 74, and the intermediate cylinders 65, 75; the control unit 83 receives the instructions of the mode switching switch 84b and the head portion finding switch 84c, and drives and controls the driving unit 81 and, thereby, can rotate and stop the blanket cylinder 63, the impression cylinders 64, 74, and the intermediate cylinders 65, 75 to/at the working angles to oil each of the oiling positions 63a, 63b, 64a, 64b, 65a, 74a, 74b, 75a, 75b of the blanket cylinder 63, the impression cylinders 64, 74, and the intermediate cylinders 65, 75.

Therefore, after selecting the stopping-for-oiling pattern using the mode switching switch 84b, by only pressing the head portion finding switch 84c, the control unit is caused to drive and control the driving unit 81 and, thereby, the blanket cylinders 63, 73, the impression cylinders 64, 74, and the intermediate cylinders 65, 75 are securely rotated to the oiling angles. Therefore, the blanket cylinders 63, the impression cylinders 64, 74, and the intermediate cylinders 65, 75 can be stopped easily and with high precision respectively at the predetermined working positions A, B, C, D. Therefore, the maintenance work can be easily executed, the load on the worker can be alleviated, and the workability can be improved.

In the embodiment, after selecting the stopping-for-oiling pattern using the mode switching switch 84b, by only pressing the head portion finding switch 84c, the blanket cylinders 63, the impression cylinders 64, 74, and the intermediate cylinders 65, 75 are adapted to be sequentially stopped at the plurality of oiling angles. Therefore, even when a plurality of oiling positions is present in each of the cylinders, the oiling work can easily be executed by stopping sequentially at the plurality of oiling angles.

Furthermore, in the embodiment, the storing unit 85 is provided that has sequentially stored therein the plurality of oiling angles for the blanket cylinders 63, 73, the impression cylinders 64, 74, and the intermediate cylinders 65, 75. Therefore, the storing unit 85 has sequentially stored therein the plurality of oiling angles for each of the cylinders and, thereby, each of the cylinders can automatically be stopped at the plurality of oiling positions and the oiling work can easily be executed.

In this case, the storing unit has stored therein the plurality of stopping-for-oiling patterns, and the control unit 83 receives the instructions of the mode switching switch 84b of the operating unit 84 and selects and executes the predetermined stopping-for-oiling pattern from the plurality of stopping-for-oiling patterns. Therefore, by storing the plurality of stopping-for-oiling patterns in the storing unit 85, the worker selects the predetermined stopping-for-oiling pattern from the plurality of stopping-for-oiling patterns when the work is executed and, thereby, the control unit 83 executes the predetermined stopping-for-oiling pattern and the each of the cylinders can automatically be stopped at the plurality of oiling positions and the oiling work can easily be executed.

In each of the above embodiments, the blanket cylinders, the impression cylinders, and the intermediate cylinders are adapted to be stopped at the predetermined working positions at witch the blanket replacing work and the oiling work are executed. However, for example, a printing cylinder as another printing press cylinder may be stopped at predetermined working positions at which maintenance work can be executed or each of the ink rollers of the ink apparatus may be stopped at predetermined working positions at which maintenance work may be executed.

### INDUSTRIAL APPLICABILITY

The printing press according the present invention facilitates improvement of workability in various types of maintenance work by stopping printing press cylinders at predetermined rotation positions with high precision, and the present invention can be applied to any printing press.

1. A printing press that executes printing therein by supplying a printing sheet from a paper feeding unit through an intermediate cylinder, by supplying ink from an ink apparatus to a blanket cylinder through a printing cylinder, and by transferring the ink from the blanket cylinder to the printing sheet when the printing sheet passes between the blanket cylinder and an impression cylinder, comprising
a head portion finding unit that rotates and stops at least any one of the intermediate cylinder, the printing cylinder, the blanket cylinder, and the impression cylinder to/at a predetermined working position.

2. The printing press of claim 1, wherein
the head portion finding unit stops the blanket cylinder at an angle for replacing a blanket wound around the blanket cylinder.

3. The printing press of claim 2, wherein
an end of the blanket in the winding direction thereof is fixed on a gripping side winding shaft of the blanket cylinder while the other end of the blanket in the winding direction thereof is fixed on the gripping tail side winding shaft of the blanket cylinder, and
the head portion finding unit stops the blanket cylinder at a work angle to fix the end of the blanket on the gripping side winding shaft and a work angle to fix the other end of the blanket on the gripping tail side winding shaft.

4. The printing press of claim 2, wherein
a supporting bar to apply predetermined tension to the blanket to be wound around the blanket cylinder is provided in the vicinity of a position for replacing work of the blanket of the blanket cylinder.

5. The printing press of claim 1, wherein
the head portion finding unit stops the intermediate cylinder or the blanket cylinder or the impression cylinder at an oiling angle.

6. The printing press of claim 5, wherein
the head portion finding unit stops the intermediate cylinder or the blanket cylinder or the impression cylinder sequentially at a plurality of oiling angles.

7. The printing press of claim 6, wherein
the head portion finding unit has a storing unit that has sequentially stored therein a plurality of oiling angles for the intermediate cylinder or the blanket cylinder or the impression cylinder.

8. The printing press of claim 7, wherein
the storing unit has stored therein a plurality of stopping-for-oiling patterns, and
the head portion finding unit selects and executes a predetermined stopping-for-oiling pattern from the plurality of stopping-for-oiling patterns in response to a head portion finding instruction.
